(19) United States
(12) Patent Application Publication
(10) Pub. No.: US 2009/0256411 A1
(43) Pub. Date: Oct. 15, 2009

(54) Emergency Information Seatbelt Attachment

(76) Inventors: Birdie L Vallowe, Belleville, IL (US); Stephen T. Hossick, Rosiclare, IL (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/988,454

(22) PCT Filed: Nov. 9, 2006
(86) PCT No.: PCT/US06/43817

§ 371 Date: Jan. 8, 2008

Related U.S. Application Data
(60) Provisional application No. 60/737,773, filed on Nov. 18, 2005.

(51) Int. Cl. B60R 22/00

(52) U.S. Cl. 297/482

(57) ABSTRACT

The emergency information seatbelt attachment (10) provides an identification and information-bearing badge (14), which is releasably mounted on a seatbelt (16) and may be secured to, and transported with, a user in the case of an accident or other emergency. A flexible sheet (12) is provided, which may be wrapped around and secured to the seatbelt (16). The badge (14) includes a releasable fastener for releasably securing the badge (14) to the flexible sheet (12). Identification and personal information is imprinted on a removable card, which is removably received within a pocket formed in the badge (14), and which is displayed through a transparent window formed in an upper surface of the badge (14).

### TECHNICAL FIELD

The present invention relates to emergency identification cards, and particularly to an emergency information seatbelt attachment including a sleeve releasably attachable to the shoulder harness of a seatbelt and an emergency identification cardholder releasably attached to the sleeve, the cardholder also having an elastic band for attaching the cardholder to a limb of a person requiring medical attention.

### BACKGROUND ART

Identification and information bearing bracelets and badges are common in the medical field, both for identifying a particular patient and identifying the patient's medical needs in a hospital setting, as well as for permanent everyday usage, providing medical-related information to health care providers in an emergency situation. Such bracelets and badges, however, are typically designed for permanent or semi-permanent wear on the user's wrist, and are not adapted for mounting on any other support surface. Thus, in order to be effective, the badge or bracelet must be worn at all times, which can be uncomfortable and inconvenient for the user.

Identification cards containing information relating to a person's medical conditions, e.g., heart impairments, blood type, drug allergies, diabetes, and other conditions that may have a bearing on medical treatment in an emergency, are also well known. Such cards may be worn on a necklace or chain worn on the neck, but are more frequently carried in a wallet or in a purse. In an emergency, the first responders often do not have time to go through the person's personal possessions to obtain medical information that may be critical to the administration of various forms of emergency medical care. Furthermore, purses, wallets, and other personal possessions in which emergency identification cards are carried may become separated from the injured person when transporting the injured person from the scene of an accident to an emergency medical treatment facility.

Other information bearing systems have been utilized to display personal and media-related information, such as signs, generalized displays and attachable cuffs or wallets for a seatbelt in a vehicle. These displays, however, are typically either permanently mounted or designed for attachment only to a single type of support surface. If such a display is utilized for medical information, the display cannot be easily transported along with an injured user, who may have to be moved from a vehicle, for example, to a health care facility. It would be preferable to provide a system that could be mounted in the vehicle and be easily transported with, and secured to, the user in the case of an emergency. Thus, an emergency information seatbelt attachment solving the aforementioned problems is desired.

### DISCLOSURE OF INVENTION

The disclosure is directed to an emergency information seatbelt attachment. The attachment includes a flexible sheet and mating first and second releasable fasteners that are attached to the flexible sheet. The fasteners releasably secure a first edge of the flexible sheet to a second edge of the flexible sheet and thereby form a tubular sleeve that is adapted for releasably gripping a seatbelt. The attachment also includes a cardholder that defines a pocket and an emergency identification card that is disposed in the pocket so that the card and the cardholder form a badge. An elastic band is attached to the cardholder. The elastic band is dimensioned and configured so that the badge can be attached to a limb of an injured person. The attachment further includes mating third and fourth releasable fasteners that are attached to the cardholder and the flexible sheet, respectively.

### BRIEF DESCRIPTION OF THE DRAWINGS

FIG. 1 is an environmental, perspective view of an emergency information seatbelt attachment according to the present invention.

FIG. 2 is a top view of the emergency information seatbelt attachment according to the present invention.

FIG. 3 is an exploded side view of the emergency information seatbelt attachment according to the present invention.

FIG. 4 is a perspective view of the badge of the emergency information seatbelt attachment of the present invention attached to the wrist of a user.

FIG. 5 is an environmental, perspective view of an alternative embodiment of the emergency information seatbelt attachment according to the present invention.

Similar reference characters denote corresponding features consistently throughout the attached drawings.

### BEST MODES FOR CARRYING OUT THE INVENTION

The emergency information seatbelt attachment provides an identification and information-bearing badge, which is releasably mounted on a seatbelt, and may be secured to, and transported with, a user in the case of an accident or other emergency. A flexible sheet is further provided, which may be wrapped around and secured to the seatbelt. The flexible sheet is formed from a soft fabric and may include padding for comfort and to prevent further injury to the user in an accident or other emergency. The flexible sheet includes releasable fasteners, such as hook and loop-type fasteners, to secure the fabric sheet around the seatbelt.

The badge includes an emergency identification card and a cardholder having a releasable fastener for releasably securing the badge to the flexible sheet. Identification and personal information such as pre-existing medical conditions, is imprinted on the identification card, which is removably received within a pocket or compartment formed in the cardholder and displayed through a transparent window formed in an upper surface of the cardholder. The identification and personal information may further include biographical information, medical information, identification information, or a photograph of the user. The badge further includes a flexible, elastic strap secured to the lower surface thereof for securing the badge to a limb of the user.

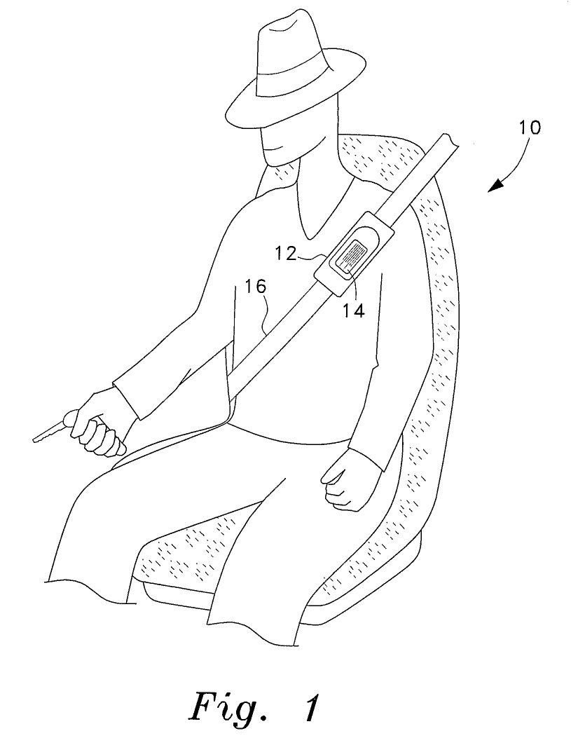

As illustrated in FIG. 1, the emergency information seatbelt attachment 10 provides a flexible sheet 12, which may be wrapped around and secured to a seatbelt 16, or more particularly, the shoulder harness portion of the seatbelt 16. A badge 14 is releasably mounted on the flexible sheet 12, and displays personal, identification and medical information related to the user. In the event of an emergency, such as an automobile accident, emergency service providers can quickly and easily remove badge 14 from the flexible sheet 12 and the seatbelt 16, and attach the badge 14 to a limb of the user when transporting the injured person to an emergency medical treatment facility. Thus, the user's identification, personal and medical information are provided to any health care or emergency personnel who may encounter and assist the user.

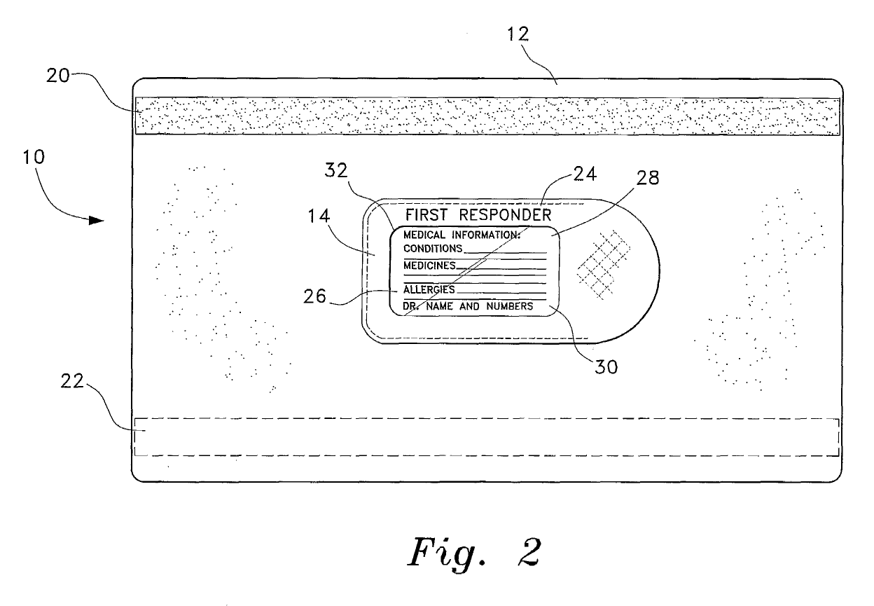

FIG. 2 illustrates the flexible sheet 12 in a flat configuration, unwrapped from the seatbelt 16 of FIG. 1. Flexible sheet 12 may be formed of any suitable material. However, a relatively soft material, such as a cloth or felt fabric, is preferred for the comfort of the user, and further to insure that the user is not injured by the contact of sheet 12 with the user's body in the event of an accident. In order to enhance safety and comfort for the user, flexible sheet 12 may further include a padded filling material housed within.

A first releasable fastener 20 is secured to the front face of flexible sheet 12, along a first edge, as shown in FIG. 2. A corresponding second releasable fastener 22 is secured to the rear face of flexible sheet 12, along an opposite second edge. First releasable fastener 20 engages second releasable fastener 22 in order to form a tubular sleeve for wrapping around seatbelt 16. In the tubular configuration, when wrapped around seatbelt 16, the flexible sheet 12 frictionally engages seatbelt 16 in order to maintain its position with respect to seatbelt 16. Releasable fasteners 20 and 22 are selected to be easily and quickly detachable for emergency usage, and may be hook and loop-type fasteners, for example, as shown in FIG. 2.

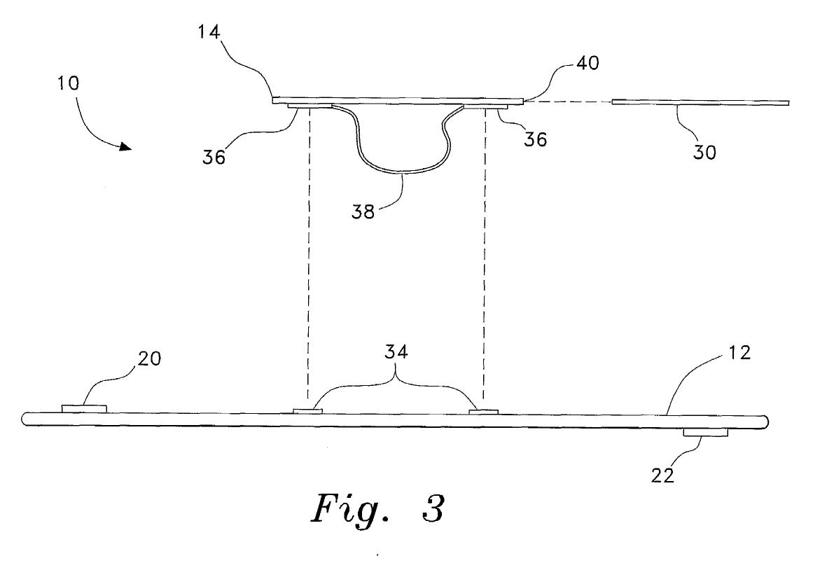

As best shown in FIG. 3, badge 14 includes a cardholder that is releasably secured to the front face of fabric sheet 12 by third and fourth releasable fasteners 34, 36, respectively. As with releasable fasteners 20, 22, described above, third and fourth releasable fasteners 34, 36 are selected to be easily and quickly detachable in the event of an emergency, and may be hook and loop-type fasteners.

The badge 14 includes an emergency identification card 30 formed from a relatively stiff and substantially waterproof material, which will not be damaged by exposure to water, bodily fluids or other emergency conditions, such as a hard plastic material. As seen in FIG. 2, personalized information 26, including, but not limited to, identification information, biographical information and medical information, is imprinted the card 30, which is received within a pocket or compartment formed in the cardholder element of badge 14 via a slot 40 formed in the side edge of the cardholder element of badge 14. As shown in FIG. 2, the upper portion of the cardholder has a window 32 formed therein, allowing the information 26 to be displayed to the user. The window 32 includes a transparent cover 28, which allows the information 26 to be clearly displayed to the user, but protects the card 30 from damage. Indicia 24 may be printed on the upper surface of the cardholder element of badge 14, alerting emergency personnel as to the nature of the seatbelt attachment 10. In addition to including identification and medical information, such as past medical conditions, medicines the user is taking, allergies, and names and telephone numbers of the user's physicians, and other text information, the card 30 may have the user's photograph imprinted thereon for further identification purposes. Similarly, the user's photograph may be imprinted on the upper surface of the cardholder element of badge 14.

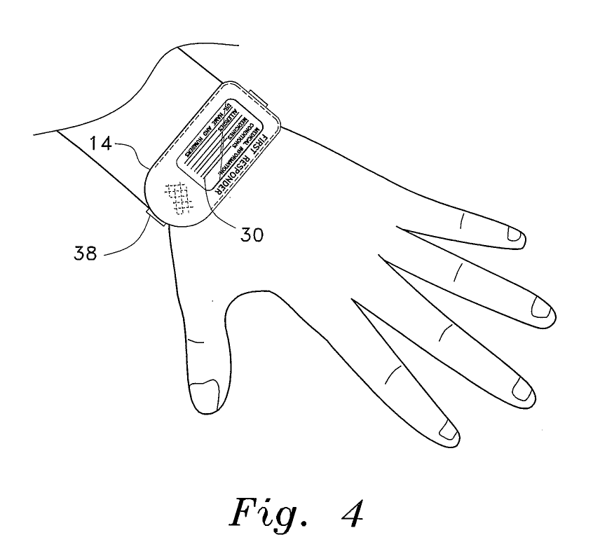

As shown in FIG. 3, a flexible elastic strap 38 is mounted on the lower surface of the cardholder element of badge 14. Strap 38 is dimensioned and configured to easily and securely fit around a user's limb, such as an adult's wrist or around a child's leg. As shown in FIG. 4, once the badge 14 has been detached from the flexible sheet 12, the badge 14 may be secured to the user (around the user's wrist in the example of FIG. 4), so that the identification information 26 displayed thereon will be transported with the user.

Although shown as including a single badge 14, it should be understood that multiple badges may be secured to flexible sheet 12. For example, badges 14 for both the driver and passenger of an automobile may be secured in a side-by-side manner onto a single flexible sheet 12, which is secured to a seatbelt 16. Further, it should be understood that flexible sheet 12 may be wrapped around any suitable support surface, particularly if a seatbelt is not available for usage, such as the flexible straps provided on a gym bag or the like.

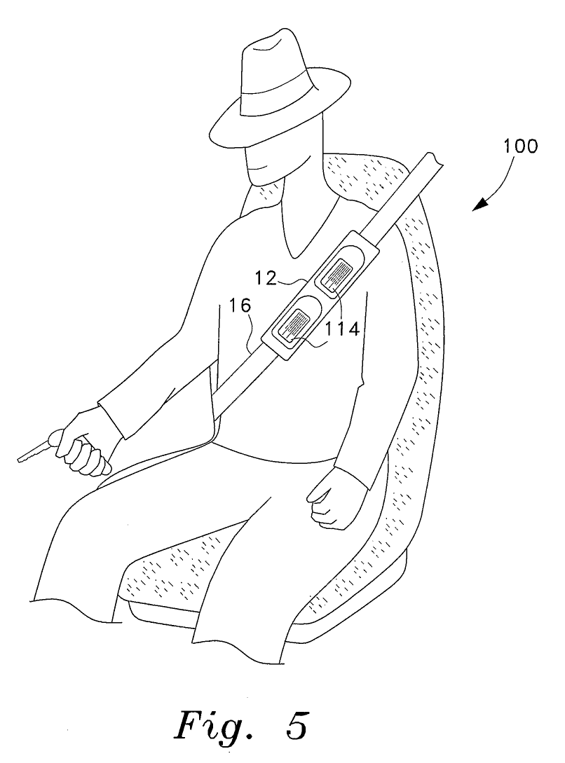

Alternatively, as shown in the embodiment of FIG. 5, the emergency information seatbelt attachment 100 includes a pair of badges 114, which may be provided for releasable attachment to flexible sheet 12, in a manner similar to that described above with regard to the single badge 14 secured to flexible sheet 12. In the embodiment of FIG. 5, a pair of badges 114 are provided, with each bearing the information for one of two drivers, one of two passengers, or one of a driver and a passenger, all riding in the same vehicle. Although shown as providing two such badges 114, it should be understood that any desired number of badges 114, with each corresponding to an individual occupant of the vehicle, may be releasably secured to flexible sheet 12. It should be understood that badges 114 (and badges 14 of FIGS. 1-4) may have any desired shape or contour. Similarly, flexible sheet 12 may have any shape or contour.

It is to be understood that the present invention is not limited to the embodiment described above, but encompasses any and all embodiments within the scope of the following claims.

1. An emergency information seatbelt attachment, comprising:
a flexible sheet having a front surface, a rear surface, a first edge, and a second edge opposite the first edge;
mating first and second releasable fasteners attached to the flexible sheet for releasably securing the first edge to the second edge, forming a tubular sleeve adapted for releasably gripping a seatbelt;
a cardholder defining a pocket;
an emergency identification card disposed in the pocket, the card and the cardholder forming a badge;
an elastic band attached to the cardholder, the band being dimensioned and configured for attaching the badge to a limb of an injured person; and,
mating third and fourth releasable fasteners attached to the cardholder and the flexible sheet, respectively.

2. The emergency information seatbelt attachment as recited in claim 1, wherein said emergency identification card further comprises at least one display surface having personal identification and medical information imprinted thereon for use by medical personnel in an emergency.

3. The emergency information seatbelt attachment as recited in claim 2, wherein said cardholder has a window defined therein, at least a portion of the display surface being visible through the window when said emergency identification card is disposed within the pocket.

4. The emergency information seatbelt attachment as recited in claim 3, further comprising a transparent cover disposed within said window and covering said emergency identification card.

5. The emergency information seatbelt attachment as recited in claim 3, wherein said cardholder has an upper surface and a lower surface, said third releasable fastener being mounted to the lower surface of said cardholder, said window being formed through the upper surface, the upper surface and the lower surface defining said pocket therebetween.

6. The emergency information seatbelt attachment as recited in claim 5, wherein said elastic band is mounted to the lower surface of said cardholder.

7. The emergency information seatbelt attachment as recited in claim 5, further comprising identification indicia imprinted on the upper surface of said cardholder adjacent said window.

8. The emergency information seatbelt attachment as recited in claim 1, further comprising a second badge releasably secured to said flexible sheet.
